(19) United States
(12) Patent Application Publication
(10) Pub. No.: US 2025/0110202 A1
(43) Pub. Date: Apr. 3, 2025

(54) AUTOMOTIVE SENSOR MODULE WITH BACKSCATTERING CANCELLATION

(71) Applicant: Magna Electronics, LLC, Southfield, MI (US)

(72) Inventors: Konstantinos Konstantinidis, Wurzburg (DE); Angelos Alexanian, Lexington, MA (US)

(21) Appl. No.: 18/375,849

(22) Filed: Oct. 2, 2023

(51) Int. Cl. G01S 7/02; G01S 7/03; G01S 13/931

(52) U.S. Cl. CPC G01S 7/023; G01S 7/03; G01S 13/931

(57) ABSTRACT

Antenna assemblies, such as RADAR sensor antenna assemblies, that incorporate destructive interference elements. In some embodiments, the assembly may comprise one or more waveguides, one or more antenna slots, and a plurality of destructive interference elements. The destructive interference elements may be configured to reduce backscatter radiation by contributing to destructive interference of electromagnetic waves incident upon the destructive interference elements. In some embodiments, the destructive interference elements may comprise at least two distinct types of destructive interference elements arranged adjacent to one another on the outer surface, in some cases in a repeating pattern.

### SUMMARY

Disclosed herein are various embodiments of sensor assemblies and related elements, sub-assemblies, and manufacturing methods. In preferred embodiments and implementations, such assemblies may comprise RADAR sensor modules for vehicles, including one or more novel and inventive features disclosed herein.

For example, in some embodiments disclosed herein, an antenna and/or waveguide block, which may comprise a single structure, layer, casting, and/or molded piece, may comprise one or more surfaces configured with features configured to facilitate the destructive interference of backscattered electromagnetic waves. In some embodiments, such surface(s) may be formed with a repeating pattern including one or more sets of individual scattering elements. Taken together, such scattering elements and/or sets can be used to provide a phase difference, in some cases within a broad frequency range, to achieve destructive interference of backscattered radiation.

To illustrate with a more specific, non-limiting example, some embodiments may incorporate elements, such as two or more artificial magnetic conductor (AMC) elements, in some cases including one or more perfect electric conductor (PEC) elements. It should be understood that, because PEC's do not strictly exist in nature, the PEC elements disclosed herein are those intended to approximate PEC's.

Moreover, the PEC elements disclosed herein should be distinguished from the AMC elements disclosed herein by virtue of the fact that PEC elements are typically characterized by low surface impedance and/or the ability to act as a mirror for incident electromagnetic waves, thereby creating a 180-degree reflection phase. By contrast, AMC elements are designed to mimic the behavior of perfect magnetic conductors, which have a very high surface impedance and typically do not invert, or at least minimize the inversion of, the phase of reflected electromagnetic waves. Thus, AMCs are typically a periodic arrangement of units and/or unit cells that have these non-inverting properties with respect to incident electromagnetic waves. Thus, it should be understood that, instead of the terms “AMC” or “PEC,” some embodiments may be referred to herein as comprising AMC-like and/or PEC-like scattering elements. Similarly, some embodiments may be referred to as comprising a pattern of scattering elements including elements configured to promote a 180-degree phase shift of incident electromagnetic waves and/or including elements configured to avoid inverting the phase of incident electromagnetic waves upon reflection.

In the case of a pattern/surface having a combination of PEC and AMC structures, destructive interference may be obtained at a specific frequency. This may therefore limit the operational bandwidth, but still achieve backscattering reduction. Alternatively, other solutions may be configured to achieve destructive interference in a broader frequency range.

For example, by using two different types of scattering elements in an array and/or pattern, such as two different types of AMC elements, one can be configured to provide a reflection phase of zero degrees, or about zero degrees, around a frequency of interest. The other type of scattering element can then be configured to provide a reflection phase of 180 degrees, or about 180 degrees, around the same frequency. Alternatively, the two elements can be configured such that the difference of their respective reflection phases is equal to, or at least about equal to, 180 degrees, without themselves having reflection phases of zero and 180 degrees.

As another example, an array and/or pattern may be configured with three different types of scattering elements, such as two AMC elements and one PEC element. The two AMC elements may be configured to have a reflection phase of zero degrees, or about zero degrees, about two distinct frequencies. For example, one may have a reflection phase of zero degrees, or about zero degrees, at 76 GHz and the other may have a reflection phase of zero degrees, or about zero degrees, at 81 GHz. The reflection phase difference will then be smoother and, when combined with PEC elements, may result in a more broadband cancellation effect.

In some embodiments, the height of the scattering elements may be used to define the frequency at which the reflection phase will cross zero degrees. The shape, type, and/or size of the elements can also be used to tune the performance of the scattering array/configuration. For example, when two sets of AMC-like elements are used, the reflection phase difference may be tuned by adjusting the size and/or periodicity of the elements along the array/pattern/configuration. Use of complimentary elements—e.g., elements having a corresponding negative shape and/or size in the same pattern/array, may be useful to achieve scattering cancellation.

As yet another example, an array and/or pattern utilizing three or more distinct types of scattering elements, such as three AMC elements, may be used. In some such cases, two of the elements, such as two distinct AMC or AMC-like elements, preferably in a repeating pattern, may both be configured to provide a phase difference of zero degrees, or about zero degrees, around a frequency range of interest. A third element, or in some cases third and fourth elements, may then be used to obtain a smooth reflection phase variation of 180 degrees around the same frequency range.

In some embodiments, such as embodiments comprising multiple, distinct AMC-like elements, broadband cancellation may be achieved by using complimentary and/or negative elements.

In some embodiments, these scattering features, patterns, and/or structures may be formed on a surface, or more than one surface, of a structure (in some cases a single layer or unitary structure) on which one or more waveguides and/or antenna slots are formed. For example, an array of one or more waveguide grooves may be formed, with such grooves being formed, for example, by way of opposing rows of posts or trench-style waveguide grooves. Antenna slots may be formed in this same layer/structure, in some cases at a terminal end of each waveguide. These antenna slots may then extend from the waveguide side of the structure to the scattering side of the structure onto which the aforementioned scattering pattern/structures may be formed.

Of course, using the principles disclosed herein, it is contemplated that similar scattering patterns/structures may be formed on other waveguide, antenna, and/or sensor structures. For example, some sensor assemblies may have antenna slots or other antennae structures formed in a separate layer. However, the principles disclosed herein may still allow for backscattering cancellation to improve performance of the sensor.

In a more specific example of a vehicle sensor assembly according to some embodiments, the assembly may comprise one or more waveguides. Each of one or more antenna slots may be operably coupled with at least one waveguide of the one or more waveguides. The assembly may further comprise an array of scattering elements, which may be arranged in a repeating pattern. In some embodiments, the pattern may comprise a first set of scattering elements and a second set of scattering elements distinct from the first set of scattering elements.

In some embodiments, each of the one or more waveguides, the one or more antenna slots, and the array of scattering elements may be formed in a single-layered structure. Other layers may, of course, be added to this single layer to form a more complete assembly. In some such embodiments, the single-layered structure may comprise a waveguide block, such as a casting.

In some embodiments, each of the one or more waveguides may be formed on a first surface of the single-layered structure. Similarly, in some embodiments, the array of scattering elements may be formed on a second surface of the single-layered structure on an opposite side of the single-layered structure relative to the first surface.

In some embodiments, each member of the first set of scattering elements may comprise a plurality of scattering elements. In some such embodiments, each member of the second set of scattering elements may also comprise a plurality of scattering elements.

In some embodiments, the first set of scattering elements may comprise protruding scattering elements. The second set of scattering elements may similarly comprise protruding scattering elements. Alternatively, however, the second set of scattering elements may comprise recessed scattering elements. In some such embodiments, the recessed scattering elements may be formed in at least substantially a complementary, negative shape relative to the protruding scattering elements. In some such cases, the complementary, negative shape may be identical, or at least substantially identical, in shape and size relative to the protruding scattering elements.

Some embodiments may comprise additional sets of scattering elements, such as a third set and, in some cases, a fourth set.

In some embodiments, each of the scattering elements of the first set of scattering elements may comprise an artificial magnetic conductor. Similarly, each of the scattering elements of the second, third, and/or fourth sets may comprise an artificial magnetic conductor. Alternatively, however, one or more of the scattering elements may comprise a structure designed to approximate a perfect electric conductor.

In some embodiments, each member of the first set of scattering elements comprises a plurality of protruding cuboids. In some such embodiments, each member of each of the second set of scattering elements comprises a single protruding cuboid. In some such embodiments, each protruding cuboid of each member of the second set occupies an area equal, or at least substantially equal, to an area occupied by the plurality of protruding elements of each member of the first set.

In some embodiments, each scattering element in the array of scattering elements is spaced apart from each antenna slot of the one or more antenna slots by a distance of at least one-half of a wavelength of electromagnetic radiation used by the vehicle sensor assembly. In some such embodiments, this minimum distance is measured in a direction perpendicular to a direction of an elongated axis of each of the one or more antenna slots. In some embodiments utilizing a 76-81 GHz RADAR frequency band, this minimum distance D May 2 mm, or about 2 mm.

In some embodiments, each of the one or more waveguides may be defined in between two or more rows of opposing posts.

In a specific example of an antenna module according to some embodiments, the module may comprise one or more waveguides defined on an inner surface. One or more antenna slots configured to deliver electromagnetic radiation to and/or from a corresponding waveguide therethrough may extend between the inner surface and an outer surface. A plurality of destructive interference elements may be positioned on the outer surface. The destructive interference elements may be configured to reduce backscatter radiation by contributing to destructive interference of electromagnetic waves incident upon the destructive interference elements. In some embodiments, the plurality of destructive interference elements may comprise at least two distinct types of destructive interference elements arranged adjacent to one another on the outer surface.

In some embodiments, the at least two distinct types of destructive interference elements may comprise protruding elements and recessed elements. In some such embodiments, the recessed elements may be formed in at least substantially a complementary, negative shape relative to the protruding elements.

In some embodiments, the at least two distinct types of destructive interference elements may comprise protruding elements of two distinct sizes. In some such embodiments, the at least two distinct types of destructive elements may be arranged in an array defined by a repeating pattern in which a plurality of protruding elements of a first, smaller size, are positioned adjacent to a single protruding element of a second, larger size.

In some embodiments, the protruding elements may be arranged in a repeating pattern such that the area of each protruding element of a second size is the same, or at least substantially the same, as the area from which the plurality of protruding elements of the first size extend.

In some embodiments, the plurality of destructive interference elements may be configured to provide a broadband destructive interference effect.

In some embodiments, the inner surface and the outer surface may each be defined on a single structure, such as a single waveguide block. In some such embodiments, the waveguide block may comprise a thermoplastic and/or absorptive material. In some such embodiments, each of the plurality of destructive interference elements may be defined by an electrically conductive coating applied to the plastic and/or absorptive material. This coating may, in some cases, also be applied to other elements of the assembly, such as each of the posts defining the waveguides and/or the walls defining the antenna slots.

In another specific example of a vehicle sensor module according to some embodiments, the module may comprise a block comprising a first surface and a second surface opposite the first surface with one or more waveguides being defined on the first surface. One or more antenna slots may extend between the first and second surfaces. An array of scattering elements may be defined on the second surface. In some embodiments, the array may be defined by a repeating pattern comprising rows and columns comprising alternating sets of scattering elements. In some such embodiments, one or more scattering elements of a first type may be positioned in a repeating first set adjacent to one or more scattering elements of a second type in a repeating second set along the second surface.

In some embodiments, each waveguide of the one or more waveguides may be defined by a plurality of posts.

In some embodiments, the first type of scattering elements may each comprise artificial magnetic conductors.

In some embodiments, the second type of scattering elements may comprise

also comprise artificial magnetic conductors, which may have a distinct shape relative to the first type of artificial magnetic conductors. Alternatively, the second type of scattering elements may comprise the same shape, but a distinct size relative to the first type of scattering elements.

In some embodiments, the second type of scattering elements may comprise elements configured to approximate a perfect electric conductor.

In some embodiments, each member of the first set may comprise a plurality of scattering elements.

In some embodiments, each member of the second set may also comprise a plurality of scattering elements. Alternatively, each member of the second set may comprise a single scattering element. In some such embodiments, each of the single scattering elements in each member of the second set may occupy an area on the second surface that is the same, or at least substantially the same, as an area occupied by the plurality of scattering elements in each member of the first set.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 is a perspective view of a scattering/cancellation surface that may be incorporated into a more complete antenna module, such as a vehicle RADAR sensor module, according to some embodiments;

FIG. 2 is a perspective view of another scattering/cancellation surface according to other embodiments;

FIG. 3 is a perspective view of still another scattering/cancellation surface according to some embodiments;

FIG. 4 is an exploded, perspective view of an antenna/waveguide assembly including a scattering/cancellation surface configuration according to some embodiments;

FIG. 5 is a perspective view of the antenna/waveguide assembly of FIG. 4;

FIG. 6 is a perspective view of an opposite side vis-à-vis FIG. 5 of the antenna/waveguide assembly of FIG. 4;

FIG. 7 is an exploded, perspective view of an antenna/waveguide assembly according to other embodiments;

FIG. 8 is a perspective view of the antenna/waveguide assembly of FIG. 7;

FIG. 9 is a perspective view of an opposite side vis-à-vis FIG. 8 of the antenna/waveguide assembly of FIG. 7;

FIG. 10 is a perspective view of a first side of a waveguide/antenna structure having a scattering surface configuration;

FIG. 11 is a perspective view of a second side of the waveguide/antenna structure of FIG. 10; and

FIG. 12 is a cross-sectional view of a portion of another antenna/waveguide assembly.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

As used herein, the term “substantially” refers to the complete or nearly complete extent or degree of an action, characteristic, property, state, structure, item, or result to function as indicated. For example, an object that is “substantially” cylindrical or “substantially” perpendicular would mean that the object/feature is either cylindrical/perpendicular or nearly cylindrical/perpendicular so as to result in the same or nearly the same function. The exact allowable degree of deviation provided by this term may depend on the specific context. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

Similarly, as used herein, the term “about” is used to provide flexibility to a numerical range endpoint by providing that a given value may be “a little above” or “a little below” the endpoint while still accomplishing the function associated with the range.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

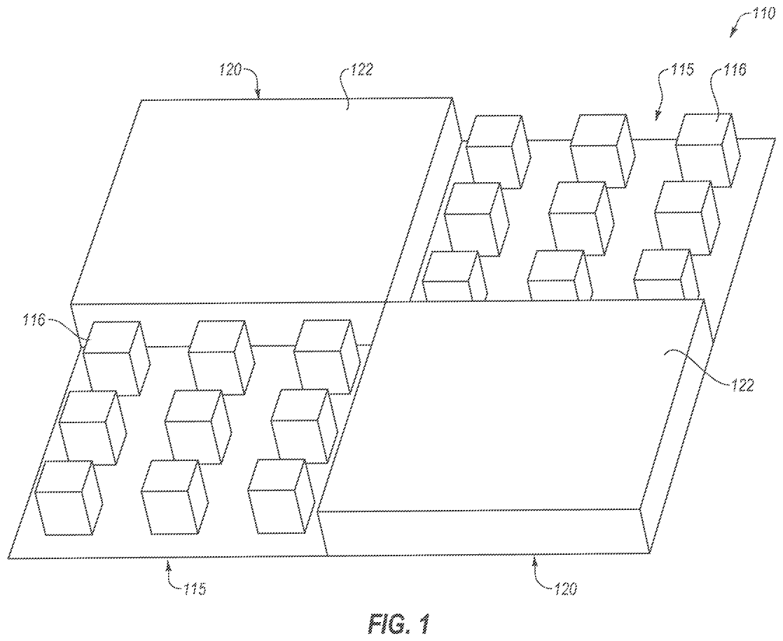

FIG. 1 depicts a portion of a scattering surface configuration 110, which may be incorporated into a module for a sensor assembly, such as a RADAR sensor assembly for a vehicle, according to some embodiments. As will be better understood in connection with later figures, the features on this surface may be spread, preferably in a repeating pattern, throughout, or at least substantially throughout given space constraints and other features need, along one or more portions and/or surfaces of a RADAR or other sensor assembly, such as in some cases along a block that may define, either in whole or in part, one or more waveguides and/or one or more antennae. Thus, although not shown in FIG. 1, it is expected that typical embodiments will also incorporate antenna slots and/or waveguides. In preferred embodiments discussed below, the waveguides may be formed on an opposite surface, on some cases an opposite surface of the same, unitary structure and/or layer, with respect to the elements of the scattering surface configuration 110 shown in FIG. 1. In some such embodiments, the antenna slots may extend from the waveguide layer through the structure/layer to the scattering surface layer.

As also described below in connection with other figures, in some embodiments, the waveguides may be defined by grooves, which grooves may be defined by posts. In some cases, the posts defining the waveguide groove(s) may comprise a first plurality of posts extending in a row and a second plurality of posts extending in another row that, in some embodiments, may be parallel to the first plurality of posts. It should be understood, however, that other grooves and/or antennae, either in the same embodiment or in other embodiments, may not be defined by any posts or other features that are shared in common with other grooves/antennae.

For example, although not depicted in the drawings, some embodiments may comprise one or more waveguides defined by trench-like walls instead of spaced posts. Similarly, some embodiments may comprise a ridge extending through the groove in between the opposing structures, whether posts or trench-like walls, defining the waveguide groove(s). Further, any or all of the waveguide and/or antennae structures discussed herein may be formed or otherwise disposed on both sides of a block, if desired, or may be formed in separate layers or other separate structures.

In preferred embodiments, the block defining the waveguides, antennae, and/or scattering elements may comprise a casting, such as a casting comprising a Zinc or other suitable preferably metal material. However, in other contemplated embodiments, this block may instead comprise a plastic or other material, which may be formed using, for example, an injection molding process. In some such embodiments, metallic inserts, coatings, or the like may be used if desired. In typical sensor assemblies, which, as previously mentioned, may be configured specifically for use in connection with vehicles, other structures may be combined with the block/casting. For example, various additional layers may be coupled to the block to form a complete antenna assembly and/or module.

The scattering element configuration of FIG. 1 comprises a repeating pattern comprising a first set of scattering elements and a second set of scattering elements distinct from the first set of scattering elements. More particularly, scattering configuration 110 comprises a first set 115 comprising members defined by sub-grids of scattering elements 116, each scattering element 116 of which comprises a protruding block or cuboid shape. Each member of the first set 115 of scattering elements 116 comprises a plurality of scattering elements 116, namely, a three-by-three array or grid of scattering elements 116. It should be understood, however, that this is but one example. The number of scattering elements 116 in each member of each repeating set 115 may vary in accordance with many contemplated embodiments.

For example, sub-grids of fewer or greater numbers of scattering elements 116 may be used, such as sub-grids each having two, four, five, or more may be used. In some embodiments, each member of each set may comprise a single scattering element. In some embodiment, uneven grids, such as those having members made up of columns and rows having numbers of individual scattering elements that do not match in number, may be used. Similarly, as discussed in greater detail below in connection with other embodiments, the shapes and/or sizes of the scattering elements may also vary as desired.

For example, rather than a cuboid shape, protruding scattering elements may be formed in a variety of preferably three-dimensional shapes, such as an X shape, a plus or cross shape, circular shapes, cylinders, rods, elliptical shapes, split rings, triangular shapes, hexahedral or other polygonal shapes, and the like. Similarly, recessed scattering elements may be formed in a variety of shapes, including negative and/or complimentary shapes to any of the shapes mentioned above. In some embodiments, the same scattering pattern and/or configuration may incorporate protruding and recessed shapes having complimentary or negative shapes that correspond to the protruding shapes in the pattern.

The repeating pattern further comprises a second set 120 of scattering elements 122, each of which comprises a single, flattened surface designed to approximate a perfect electric conductor (PEC). Thus, unlike the first set 115, each member of the second set 120 comprises a single element 122. Similarly, in preferred embodiments, each of the individual, protruding scattering elements 116 of the first set 115 may comprise an artificial magnetic conductor.

As shown in FIG. 1, each element 122 of the second set 120 occupies an area at least substantially equal to an area occupied by the plurality of protruding elements 116 of each member of the first set 115. Stated otherwise, the “footprints” of each member of both sets 115/120 are at least substantially the same along the repeating pattern shown in FIG. 1.

However, as will also be apparent in connection with a discussion of other figures below, this need not be the case along the entire surface and/or portion of a sensor assembly to which scattering elements are applied. Indeed, portions of the pattern along the edges of the surface and/or those adjacent to other elements of the module/assembly, such as the antenna slots (not shown in FIG. 1), may comprise different sizes and/or different numbers of protruding elements, as needed. Preferably, any portions of such portions/surfaces that are not occupied by other functional elements are, however, occupied by scattering elements, and it may be desirable to form the pattern using as much of a consistent pattern throughout the configuration as possible given space constraints.

As also shown in FIG. 1, the protruding, scattering elements 116 of the first set 115 protrude to the same, or at least substantially the same, height as elements 122 of set 120. However, again, this need not be the case for all embodiments.

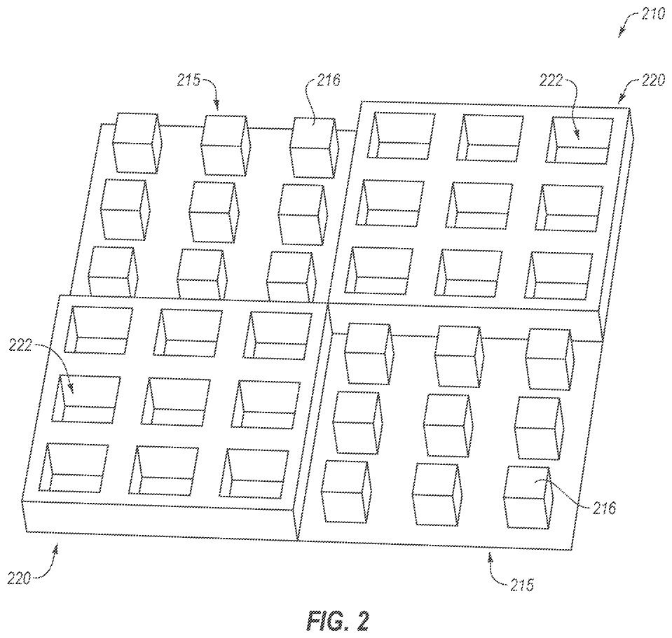

FIG. 2 depicts a portion of a scattering surface configuration 210 according to other embodiments. Again, this configuration 210 may be incorporated into a module for a sensor assembly, such as a RADAR sensor assembly for a vehicle. In addition, preferably, the features on this surface may be spread throughout one or more surfaces of a portion of such an assembly, such as along a surface of a waveguide and/or antenna block, preferably in a repeating pattern. Thus, although not shown in FIG. 2, it is expected that typical embodiments will incorporate antenna slots, waveguides, and/or other components/features of a RADAR or other sensor assembly.

The scattering element configuration of FIG. 2, like that of FIG. 1, comprises a repeating pattern comprising a first set of scattering elements and a second set of scattering elements distinct from the first set of scattering elements. More particularly, scattering configuration 210 comprises a first set 215 comprising members defined by sub-grids of scattering elements 216, each scattering element 216 of which comprises a protruding block or cuboid shape. Each member of the repeating first set 215 of scattering elements 216 comprises a plurality of scattering elements 216, namely, a three-by-three array or grid of scattering elements 216. Again, however, that this is but one example. The number of scattering elements 216 in each member of each repeating set 215 may vary in accordance with many contemplated embodiments.

For example, sub-grids of fewer or greater numbers of scattering elements 216 may be used, such as sub-grids each having two, four, five, or more may be used.

In some embodiments, each member of each set may comprise a single scattering element. Similarly, the shapes and/or sizes of the scattering elements may also vary as desired.

The repeating pattern further comprises a second set 220 of scattering elements 222, each of which comprises a plurality of recessed scattering elements 222. However, unlike the configuration of FIG. 1, the second set 220 of scattering elements 222, like the first set 215 of scattering elements 216, comprises a plurality of scattering elements 222 arranged in a grid (or sub-grid). In the depicted embodiment, the grid of the second set 220 of scattering elements 222 matches the grid of the first set 215 of scattering elements 216, both in terms of the number of scattering elements in each grid and in terms of the space/area/footprint occupied by each member of each set 215/220.

However, again, this need not be the case for all contemplated embodiments. Indeed, the space, area, and/or footprint of each member or sub-grid of the first set 215 may differ from each member or sub-grid of the second set 220 either consistently, or at least in part. For example, as shown in some more detailed embodiments discussed below, some embodiments may comprise scattering elements having repeating patterns of set members that are the same, or at least substantially the same, in space, area, and/or footprint, across much of a particular surface of a portion of a sensor assembly, but may have portions, such as portions near edges of the surface (either peripheral edges or edges near other functional elements, such as antenna slots, for example), that differ in space, area, and/or footprint. Similarly, it is contemplated that other embodiments may comprise set members/grids that are never the same and/or never repeat across the pattern on the surface in terms of space, area, and/or footprint.

As also shown in FIG. 2, each recessed scattering element 222 of each member of set 220 is formed in, at least substantially, a complementary, negative shape relative to each protruding scattering elements 216 of each member of set 215. In the depicted embodiment, these negative shapes are formed such that each of the protruding scattering elements 216 of set 215 may fit within a corresponding recessed scattering element 222 of set 220. However, again, various alternative configurations are contemplated. For example, in some embodiments, the shapes and/or sizes the recessed scattering elements need not match, or at least substantially match, the corresponding shapes and/or sizes of the protruding scattering elements. In addition, although in the depicted embodiment the heights of the protruding scattering elements 216 are the same, or at least substantially the same, as the depths of the corresponding recessed scattering elements 222, this need not be the case in all contemplated embodiments either.

As previously mentioned, in preferred embodiments, a pattern may be used in which grids of protruding scattering elements 216 forming a first set 215 (with each member of the first set 215 comprising a plurality of protruding, scattering elements 216 arranged in a grid) is arranged in a repeating pattern adjacent to grids of recessed scattering elements 222 forming a second set 220 (again, with each member of the second set 220 comprising a plurality of recessed, scattering elements 222 arranged in a grid) such that each member of set 215 is positioned adjacent to at least one (in some cases, four, depending upon which member is considered) member of set 220 in a higher-level, alternating grid. In preferred embodiments, all members of both sets 215 and 220 comprise artificial magnetic conductors.

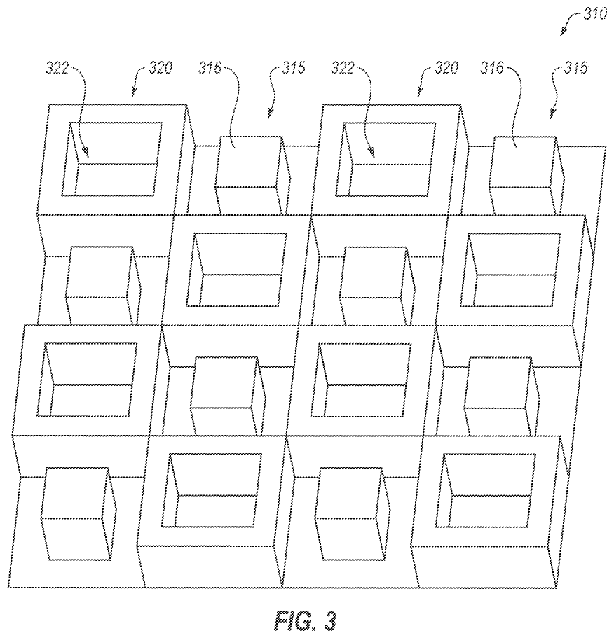

Still another example of a portion of a scattering surface configuration 310 according to other embodiments is depicted in FIG. 3. Again, this configuration 310 may be incorporated into a module for a sensor assembly, such as a RADAR sensor assembly for a vehicle. In addition, the features on this surface may be spread throughout one or more surfaces of a portion of such an assembly, such as along a surface of a waveguide and/or antenna block, preferably in a repeating pattern. Thus, although not shown in FIG. 3, it is expected that typical embodiments will incorporate antenna slots, waveguides, and/or other components/features of a RADAR or other sensor assembly.

The scattering element configuration of FIG. 3, like those of FIGS. 1 and 2, comprises a repeating pattern comprising a first set of scattering elements and a second set of scattering elements distinct from the first set of scattering elements. More particularly, scattering configuration 310 comprises a first set 315 comprising individual, protruding scattering elements 316. Each member of the repeating first set 315 of scattering elements 316 therefore comprises a single scattering element 316. Again, however, that this is but one example. The number of scattering elements 316 in each member of each repeating set 315 may vary in accordance with many contemplated embodiments. Similarly, the shapes and/or sizes of the scattering elements may also vary as desired.

The repeating pattern shown in FIG. 3 further comprises a second set 320 of scattering elements 322, each of which comprises a single, recessed scattering element 322. Like the members of set 315, each member of the second set 320 of scattering elements 322 comprises a single, recessed scattering element 322. In the depicted embodiment, the second set 320 of scattering elements 322 matches the first set 315 of scattering elements 316, both in terms of the number of scattering elements in each member of the grid (one) and as to the space/area/footprint occupied by each member of each set 315/320.

Again, this need not be the case for all contemplated embodiments. Indeed, the space, area, and/or footprint of each member or sub-grid of the first set 315 may differ from each member or sub-grid of the second set 320 either consistently, or at least in part.

As also shown in FIG. 3, each recessed scattering element 322 of each member of set 320 is formed in, at least substantially, a complementary, negative shape relative to the protruding scattering elements 316 of each member of set 315. In the depicted embodiment, these negative shapes are formed such that each protruding scattering element 316 of set 315 may fit within a corresponding recessed scattering element 322 of set 320. In other words, each protruding scattering element 316 is positioned adjacent to one or more recessed scattering elements 322, and these elements 316/322 alternate back and forth, in both horizontal and vertical directions, preferably throughout the pattern 310. In addition, in preferred embodiments, all members of both sets 315 and 320 comprise artificial magnetic conductors.

However, again, various alternative configurations are contemplated. For example, in some embodiments, the shapes and/or sizes the recessed scattering elements need not match, or at least substantially match, the corresponding shapes and/or sizes of the protruding scattering elements. In addition, although in the depicted embodiment the heights of the protruding scattering elements 316 are the same, or at least substantially the same, as the depths of the corresponding recessed scattering elements 322, this need not be the case in all contemplated embodiments either.

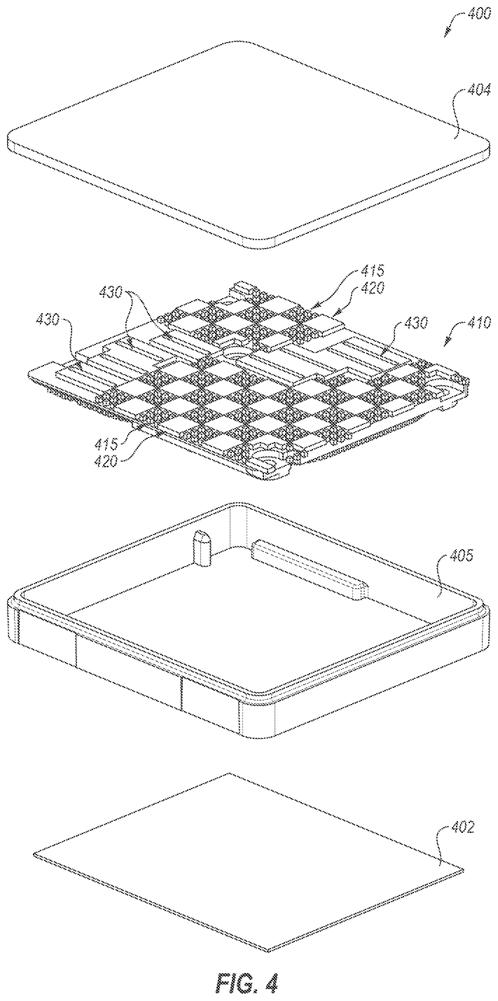

FIG. 4 depicts a RADAR sensor assembly 400 according to some embodiments. Assembly 400 comprises a frame 405, which may be used to couple various layers, such as a PCB layer 402, a radome layer 404, and an antenna/waveguide layer 410. As mentioned above, layer 410 may, in some embodiments, comprise a single-layered structure, such as a waveguide block or casting, which may comprise both waveguides and antennae.

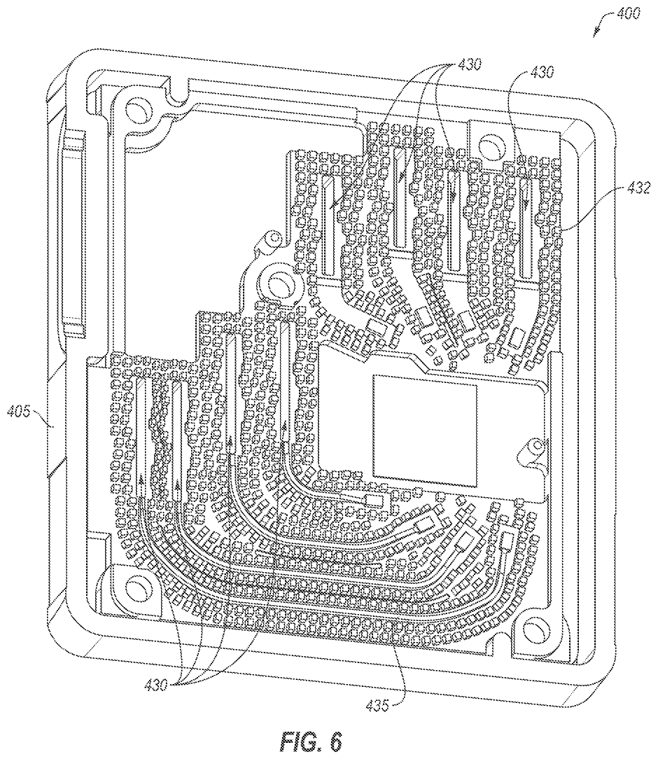

In the depicted embodiment, each of the waveguides may be formed on a first surface of the single-layered structure 410 (the bottom surface, which is not visible in FIG. 4; see FIG. 6), and an array of scattering elements may be formed on a second surface of the single-layered structure 410 on an opposite side of the single-layered structure 410 relative to the first surface—i.e., the top surface from the perspective of FIG. 4.

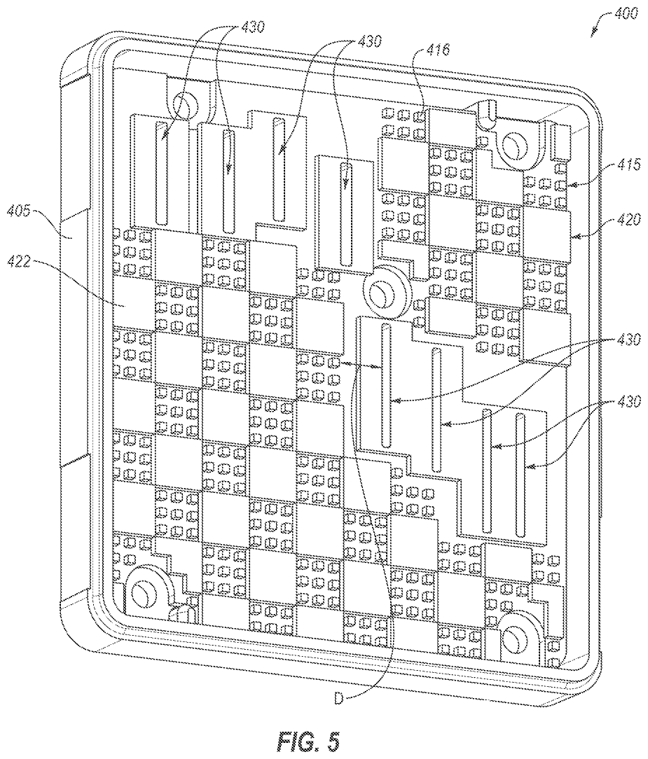

More particularly, structure 410 comprises an array of scattering elements comprising alternating rows and columns of distinct elements, namely, a first set 415 of scattering elements, each member of the set 415 comprising a grid or array of protruding, scattering elements 416, as better depicted in FIG. 5, and a second set 420 of scattering elements 422, each member of which comprises a single, flattened surface designed to approximate a perfect electric conductor (PEC). Thus, unlike the first set 415, each member of the second set 420 comprises a single element 422. Similarly, in preferred embodiments, all members of the first set 415 comprise artificial magnetic conductors.

Artificial magnetic conductors may be configured in a scattering element pattern to provide a reflection phase of zero, or about zero degrees, about a frequency of interest. By combining artificial magnetic conductors with scattering elements more akin to perfect electric conductors, a more narrowband solution may be provided, since the reflection phase slope of a PEC under normal incidence is typically 180 degrees over the frequency. Thus, perfect, or near perfect, cancellation can be achieved on a single frequency.

However, various other options may be employed to achieve a more broadband phase cancellation. Indeed, by using two different types of artificial magnetic conductors each configured to achieve a different reflection/reflection phase, broader cancellation may be achieved. For example, by providing a first artificial magnetic conductor in the pattern/configuration that is configured to provide a reflection phase relative to a first frequency of interest and a second artificial magnetic conductor configured to have a reflection phase of second frequency of interest, the phase of which may be 180 degrees shifted from the phase of the first artificial magnetic conductor, a more broadband cancellation may be achieved.

Similarly, other combinations including more than two types of artificial magnetic conductors (AMC's), or including multiple types of artificial magnetic conductors and one or more perfect electric conductors (PEC's), may be employed in order to further broaden the band of operation and/or cancellation. For example, a combination of a first AMC structure having a first reflection phase at a particular frequency, a second AMC structure having a second reflection phase at a particular frequency, and a PEC structure may be combined on a scattering configuration/pattern. The combined reflection phase difference may then be smoother and, when combined with a PEC, may result in a more broadband cancellation.

As another example offering the possibility of an even more broadband cancellation, three (or more) distinct types of AMC structures may be employed, each configured to provide a distinct reflection phase at a particular frequency or frequency range, may be used. In some cases, two of the AMC structures may be configured to provide a phase difference of zero degrees, or about zero degrees, around a frequency range of interest, whereas the third AMC structure may be configured to obtain a smooth reflection phase variation of 180 degrees, or about 180 degrees, around the same frequency range.

For purposes of this disclosure, the term “perfect electric conductor” should be construed as encompassing a surface and/or block, which may be part of a repeating scattering configuration and/or pattern, that reflects normal incident electromagnetic waves with a 180, or at least substantially 180, degree phase shift. PEC elements are typically metallic. Elements that are intended to achieve this result, although obviously without strictly qualifying as perfect electric conductors, may therefore be referred to herein as “PEC-like.”

The members of sets 415 and 420 alternate in a grid pattern preferably throughout the surface of structure 410 shown in FIG. 5, or at least throughout as much of the surface area as is reasonably possible, given various constraints, such as space occupied by other functional elements, manufacturing considerations, etc.

A series of elongated antenna slots 430 is also shown positioned along structure 410. Each of these antenna slots 430 may extend between opposing sides of structure 410—i.e., between the side shown in FIG. 5 comprising the scattering array/elements, and the side shown in FIG. 6, which defines the various waveguides of the assembly 400.

At least substantially each element 422 and member of the second set 420 occupies an area at least substantially equal to an area occupied by each of the plurality of protruding elements 416 of each member of the first set 415. However, as shown in FIG. 5, there are members of both sets 415 and 420 in which, due to space considerations, this is not the case. For example, there are regions adjacent to the peripheral edge of the assembly 400, adjacent to antenna slots 430, or adjacent to other elements of the assembly 400, in which the shapes and/or sizes of sets 415 and 420 have been modified, as shown in FIG. 5.

It should also be noted that, in the depicted embodiment and all other embodiments disclosed herein, the pattern may repeat in non-uniform and/or non-equal grids of individual scattering members/elements. For example, although in the embodiment of FIG. 5 the majority of the scattering pattern comprises protruding AMC elements in repeating 3×3 grids, these grids may be larger (such as 4×4 or 5×5), smaller (such as 1×1 or 2×2), or non-equal (such as 2×4, 4×2, 3×1, 2×3, 1×3, etc.).

However, it may be preferred in order to avoid unduly impacting the performance of the system/antennae to ensure that the scattering elements are placed symmetrically, or at least substantially symmetrically, about the phase center of the antennae, or at least a subset of the antennae, so that the radiation pattern and/or the angle estimation is not unduly affected.

As also shown in FIG. 5, preferably, a minimum distance D is therefore maintained between each of the antenna slots 430 of assembly 400 and each scattering element in the array of scattering elements, or at least a subset of the scattering elements, such as each of the protruding scattering elements 416 of set 415. In some embodiments, this distance D may be at least one-half of a wavelength of electromagnetic radiation used by the vehicle sensor assembly. Thus, in the case of an automotive RADAR sensor assembly or module utilizing a 76-81 GHz RADAR frequency band, distance D may be at least about 2 mm.

In some embodiments, distance D may be measured in a direction perpendicular to a direction of an elongated axis of each of the antenna slots 430. It should be understood, however, that some embodiments may comprise antenna slots that are non-straight. For example, the antenna slots 430 may oscillate back and forth as described in, for example, U.S. Pat. No. 11,349,220 titled “OSCILLATING WAVEGUIDES AND RELATED SENSOR ASSEMBLIES,” which issued on May 31, 2022, and is hereby incorporated by reference in its entirety. With respect to such antenna slots, it is contemplated that distance D may still be maintained from the elongated axis of the antenna slots, with the slot oscillating back and forth on opposing sides of the elongated axis from which this distance may be measured. Alternatively, however, distance D may be provided so as to maintain this distance between any portion of the antenna slots rather than the axis itself, either measured in a direction perpendicular to the axis or in any direction.

Thus, in some embodiments, either with antenna slots of various shapes and sizes or with antennae structures of other types, the minimum distance D may be maintained in any direction vis-à-vis the antenna slots 430 and/or other antennae structures. Similarly, although in some embodiments, distance D may be maintained relative to protruding, scattering elements, in some embodiments, distance D may be maintained relative to all scattering elements in the array of scattering elements.

FIG. 6 shows the opposite side of structure 410, which defines the various waveguides of the assembly 400. As shown in this figure, the waveguides may be defined by posts 432. In the depicted embodiment, each of the waveguides is defined by a plurality of rows of opposing posts 432 on either side of each waveguide. However, of course, various alternative embodiments are contemplated.

For example, a single row of spaced, adjacent posts 432 may be used to define one or more waveguides. Similarly, in other embodiments, waveguides may be defined using other structures, such as waveguides defined by continuous, trench-like walls, for example.

As also shown in FIG. 6, and as previously mentioned, antenna slots 430 are formed at a terminal end of each of the waveguides, each antenna slot 430 of which extends from the side of structure/layer 410 shown in FIG. 6 to the side shown in FIG. 5. In addition, in the depicted embodiment, a waveguide ridge 435 extends within a subset of the waveguides along the axis of each such waveguide. However, again, it should be understood that waveguide ridges 435 need not be a part of all contemplated embodiments having scattering arrays and/or elements.

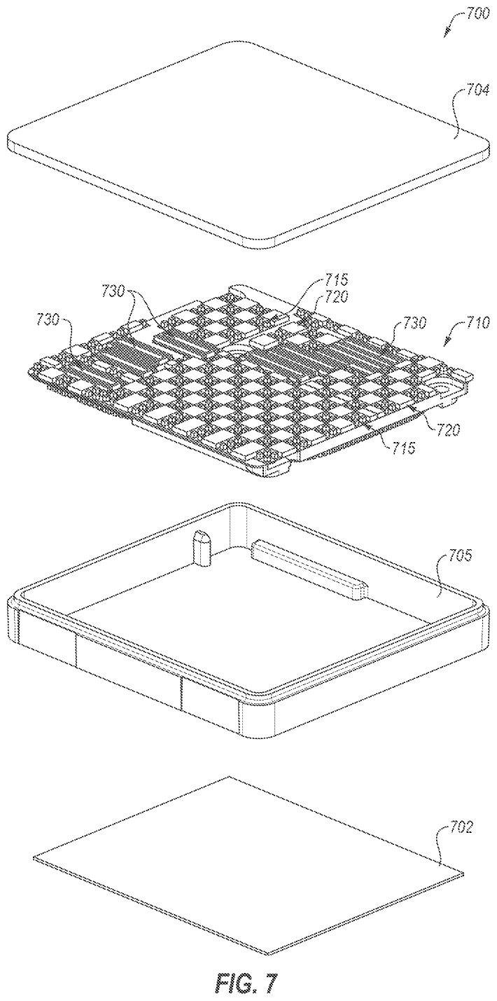

FIGS. 7-9 depict a RADAR sensor assembly 700 according to other embodiments. Assembly 700 again comprises a frame 705, a PCB layer 702, a radome layer 704, and an antenna/waveguide layer 710. Layer 710 may again comprise a single-layered structure, such as a waveguide block or casting, which may include both waveguides and antennae, and may incorporate scattering elements configured to provide destructive interference to incoming backscatter radiation.

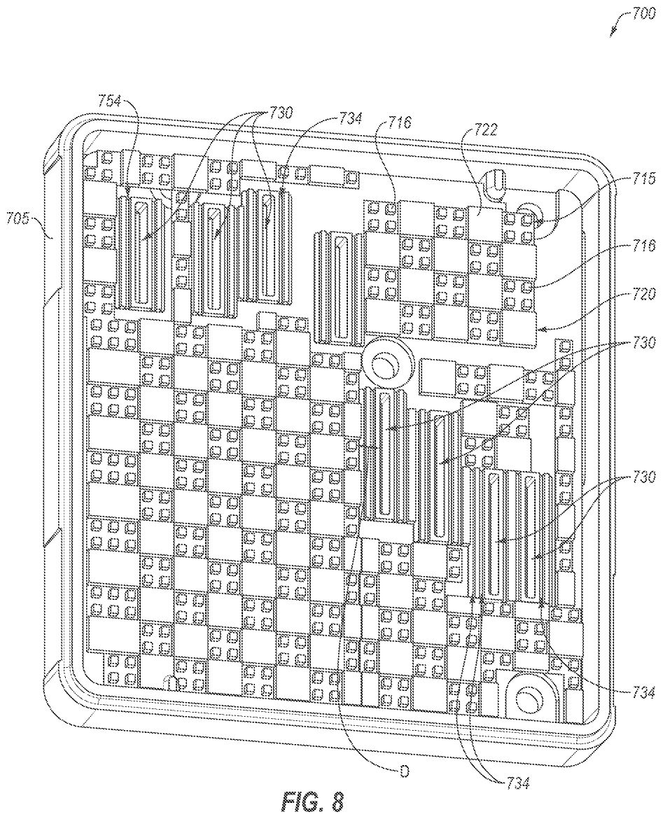

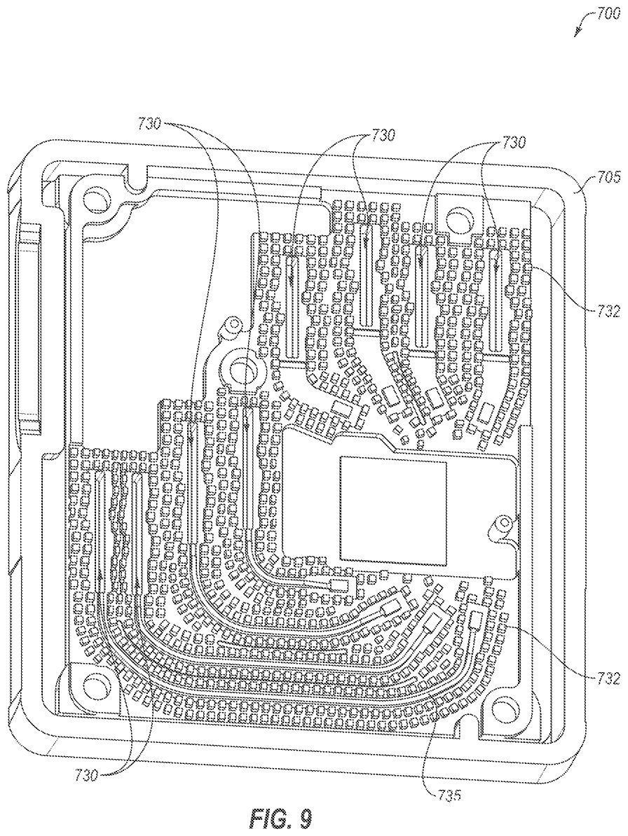

In the depicted embodiment, each of the waveguides is again formed on a first surface of the single-layered structure 710 (the bottom surface, which is shown on FIG. 9). An array of scattering elements is formed on a second surface of the single-layered structure 710 on an opposite side of the single-layered structure 710 relative to the first surface—i.e., the top surface from the perspective of FIG. 7, which is shown in greater detail in FIG. 8.

More particularly, structure 710 comprises an array of scattering elements comprising alternating rows and columns of distinct elements, namely, a first set 715 of scattering elements, each member of the set 715 comprising a grid or array of protruding, scattering elements 716, and a second set 720 of scattering elements 722, each member of which comprises a single, flattened surface designed to approximate a perfect electric conductor (PEC). Thus, unlike the first set 715, each member of the second set 720 comprises a single element 722. Similarly, in preferred embodiments, all members of the first set 715 comprise artificial magnetic conductors.

The members of sets 715 and 720 alternate in a grid pattern preferably throughout the surface of structure 710 shown in FIG. 8, or at least throughout as much of the surface area as is reasonably possible, given various constraints, such as space occupied by other functional elements, manufacturing considerations, etc.

One of the primary differences between assembly 400 and assembly 700 is the number of protruding, scattering elements 716 in each member of the set 715. In particular, the number of scattering elements 716 in each member is four, which is arranged in a sub-array or grid along each member of set 715. However, as shown in FIG. 8, some of the sets, such as some of those along the upper and right peripheral edges of the assembly 700, may comprise one or two protruding, scattering elements 716. The members of set 720 adjacent to these members may be modified to have the same, at least substantially the same, or a similar shape and/or size. Similarly, as shown along the left peripheral edge of the assembly 700, some members of sets 715 and/or 720 may be increased in size, number of individual elements, and/or shape.

A series of elongated antenna slots 730 is also shown positioned along structure 710. Each of these antenna slots 730 may extend between opposing sides of structure 710—i.e., between the side shown in FIG. 8 comprising the scattering array/elements, and the side shown in FIG. 9, which defines the various waveguides of the assembly 700.

As another distinction between assembly 400 and assembly 700, each of the antenna slots 730 comprises one or more grooves 734 that extend along and adjacent to the antenna slots 730 along one or both sides thereof. Unlike the antenna slots 730, these grooves 734 do not form an opening that extends all the way through the structure/layer into which each of these features is formed. However, these grooves 734 may otherwise be configured to resemble or mimic the antenna slots 730 without actually comprising a slot. As shown in FIG. 8, there may be some antenna slots 730 that have multiple grooves 734 adjacent to one or both sides thereof, whereas others may comprise a single groove 734 adjacent to one or both sides thereof, or a single groove 734 on one side and multiple grooves 734 on the opposite side.

Each element 722, or at least substantially each element 722, of the second set 720 occupies an area equal, or at least substantially equal, to an area occupied by each of the plurality of protruding elements 716 of each member of the first set 715. However, as shown in FIG. 8, there are members of both sets 715 and 720 in which, due to space considerations, this is not the case. For example, there are regions adjacent to the peripheral edge of the assembly 700, adjacent to antenna slots 730, or adjacent to other elements of the assembly 700, such as holes configured for fasteners, in which the shapes and/or sizes of sets 715 and 720 have been modified. For example, as shown in FIG. 8, the members of sets 715 and 720 along the left edge of the assembly 700 are slightly larger, and those along the right edge are slightly smaller.

As also shown in FIG. 8, preferably, a minimum distance D is maintained between each of the antenna slots 730 of assembly 700 and each scattering element in the array of scattering elements, or at least a subset of the scattering elements, such as each of the protruding scattering elements 716 of set 715 and/or the flattened/PEC scattering elements of set 720. In some embodiments, this distance D may be at least one-half of a wavelength of electromagnetic radiation used by the vehicle sensor assembly. Thus, in the case of an automotive RADAR sensor assembly or module utilizing a 76-81 GHZ RADAR frequency band, distance D may be at least about 2 mm.

In some embodiments, distance D may be measured in a direction perpendicular to a direction of an elongated axis of each of the antenna slots 730. However, some embodiments may comprise antenna slots that are non-straight, as previously mentioned. Thus, for example, if the antenna slots oscillate back and forth, distance D may still be maintained from the elongated axis of the antenna slots, with the slot oscillating back and forth on opposing sides of the elongated axis from which this distance may be measured. Alternatively, however, distance D may be provided so as to maintain this distance between any portion of the antenna slots rather than the axis itself, either measured in a direction perpendicular to the axis or in any direction.

Moreover, due to the presence of grooves 734, in some embodiments, distance D may be maintained from grooves 734 rather than from the antenna grooves 730 themselves, either in a direction perpendicular to the axes of the grooves 734 or, alternatively, in any direction relative to the grooves 734. However, it may be desirable for some embodiments to maintain the minimum distance D from the slots 730 rather than the grooves 734. Similarly, minimum distance D may be maintained relative to the protruding, scattering elements, such as elements 716, or distance D may be maintained relative to all scattering elements, including PEC/flat scattering elements within the array of scattering elements.

FIG. 9 depicts the waveguide side of structure 710. As shown in this figure, the waveguides may be defined by posts 732. However, again, various alternative embodiments are contemplated, including different numbers of rows of posts 732 and different types of waveguides.

As also shown in FIG. 9, antenna slots 730 are formed at a terminal end of each of the waveguides, each antenna slot 730 of which extends from the side of structure/layer 710 shown in FIG. 9 to the side shown in FIG. 8. In addition, in the depicted embodiment, a waveguide ridge 735 extends within each of a subset of the waveguides along the axis of each such waveguide.

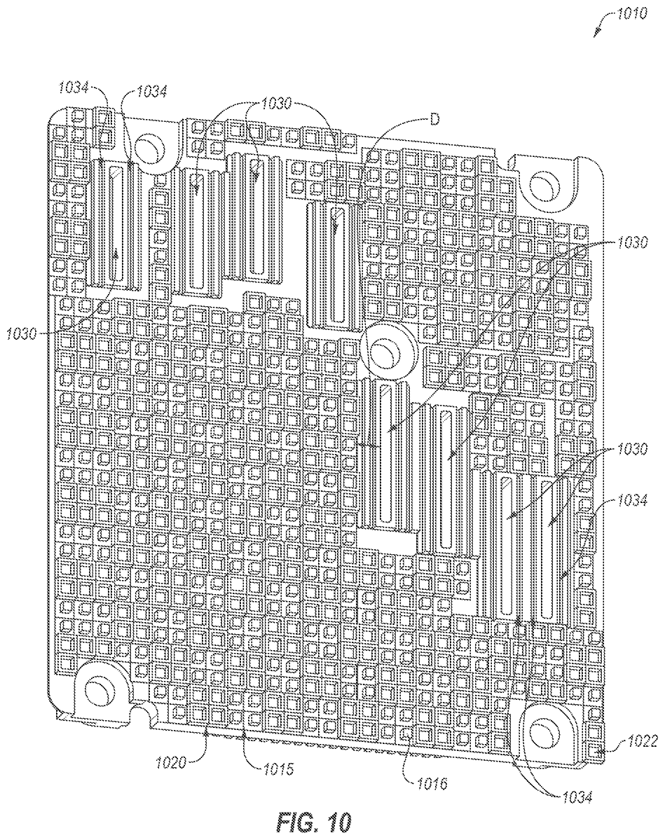

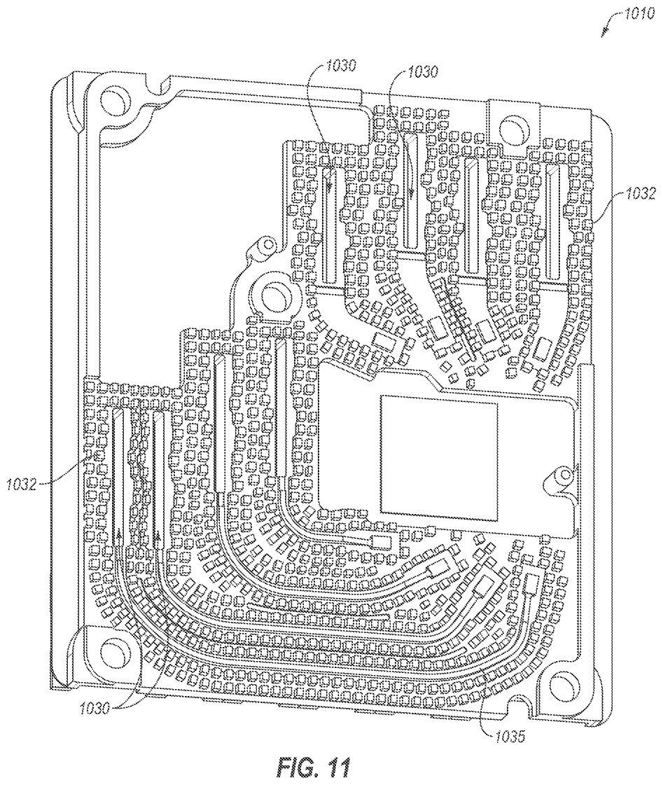

FIGS. 10 and 11 depict another embodiment of a waveguide and/or antenna structure 1010, which may be incorporated, or a portion of this structure incorporated (such as the scattering element pattern) into a more complete RADAR or other sensor assembly. As shown in FIG. 10, the scattering element pattern comprises a first set 1015 of scattering elements 1016 and a second set of 1020 of scattering elements 1022 arranged in a grid pattern or array.

Each of the scattering elements 1016 in the first set 1015 comprises a protruding, scattering element 1016 and each of the scattering elements 1022 in the second set 1020 comprises a recessed scattering element 1022. As described above, in some preferred embodiments, the members of each set 1015/1020 may comprise, along all or at least a portion (in some cases, at least substantially all) of the pattern, the same numbers of individual scattering elements 1016/1022.

Moreover, in the depicted embodiment, the members of each set 1015/1020 may occupy the same, or at least substantially the same area, space, and/or footprint.

Similarly, each individual scattering element 1016/1022 may occupy the same, or at least substantially the same, area/space/footprint. In addition, the size, shape, height, and/or depth of the protruding scattering elements 1016 may match, or at least substantially match, those of the recessed scattering elements 1022. For example, the shape and depth of the recessed scattering elements 1022 may be configured so as to define, or at least substantially define complimentary or negative shapes relative to the protruding scattering elements 1016.

As previously mentioned, in preferred embodiments, each of the individual scattering elements 1016/1022 of one or both of the members of each set 1015/1020 may comprise an artificial magnetic conductor. As also previously mentioned, and as shown in FIG. 10, in preferred embodiments, each of the individual scattering elements 1016/1022 of one or both of the members of each set 1015/1020 may be positioned to maintain a minimum distance D from the antenna slots 1030 or, alternatively, from grooves 1034, which may extend adjacent and parallel to the antenna slots 1030. Again, this distance may be about one-half of the wavelength of electromagnetic radiation used by the sensor assembly that incorporates the array/pattern depicted in FIG. 10. Thus, in the case of an automotive RADAR sensor assembly or module utilizing a 76-81 GHZ RADAR frequency band, distance D may be at least about 2 mm. Again, distance D may be measured perpendicular to the axes of the antenna slots 1030 and/or grooves 1034 or, in some embodiments, may be maintained throughout the array/pattern in any direction relative to any portion of the antenna slots 1030 or grooves 1034.

FIG. 11 depicts the waveguide side of structure 1010. As shown in this figure, the waveguides may be defined by posts 1032 or by any other type of waveguide available to those of ordinary skill in the art. Once again, antenna slots 1030 are formed at a terminal end of each of the waveguides, each antenna slot 1030 of which extends from the side of structure/layer 1010 shown in FIG. 11 to the side shown in FIG. 10. In addition, a waveguide ridge 1035 may optionally extend within each of at least a subset of the waveguides along at least a portion of the axis of each such waveguide.

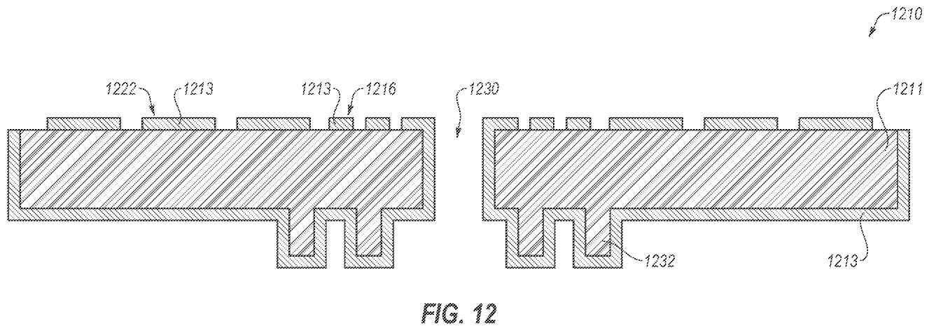

FIG. 12 is a cross-sectional view of a waveguide and/or antenna structure 1210 according to other embodiments. In this embodiment, certain materials and coatings may be selected to further improve performance of a RADAR or other sensor assembly that incorporates waveguide and/or antenna structure 1210, or other similar element(s) and/or structure(s).

More particularly, structure 1210 is shown comprising a substrate or core 1211, which may comprise a thermoplastic material, which material may, in some such embodiments, comprise an absorber or an absorptive material. Structure 1210 may comprise the bulk of the material defining structure 1210. In preferred embodiments, the plastic and/or absorptive material making up core 1211 may comprise a lossy material configured to absorb electromagnetic radiation/signals, such as RADAR signals. Thus, in some such embodiments, this lossy material may have a dielectric constant of between about 4 and about 12. In some such embodiments, the dielectric constant may be between about 6 and about 9. In a very specific example of a preferred embodiment, the dielectric constant may be about 8.

In other preferred embodiments, the plastic and/or absorptive material of core 1211 may comprise a lossy material having a dielectric constant of between about 6 and about 14. In some such embodiments, the dielectric constant may be between about 9 and about 14 or between about 6 and about 9.

In preferred embodiments, either in addition to having a preferred dielectric constant or instead of having a preferred dielectric constant, the absorptive material of core 1211 may comprise an absorptive material having a dielectric loss tangent of between about 0.1 and about 0.7. More preferably, the dielectric loss tangent of the material may be between about 0.15 and about 0.65. In some such embodiments, the dielectric loss tangent of the material may be between about 0.3 and about 0.6, or more preferably between about 0.5 and about 0.6. In a very specific example of a preferred embodiment, the dielectric loss tangent of the material may be about 0.56.

In other preferred embodiments, either in addition to having a preferred dielectric constant or instead of having a preferred dielectric constant, the absorptive material may have a dielectric loss tangent of between about 0.2 and about 0.6. In some such embodiments, the dielectric loss tangent of the material may be between about 0.3 and about 0.6, or between about 0.2 and about 0.3. Moreover, it should be understood that, within a given design, one or both of these parameters (dielectric constant and/or dielectric loss tangent) may vary within about +/−20%.

As also shown in FIG. 12 a coating and/or layer 1213 may be applied to one or more portions of the core 1211. In preferred embodiments, coating/layer 1213 may comprise an electrically conductive material, such as a metallic coating. In the depicted embodiment, coating 1213 extends along the entire waveguide surface of element 1210, including each of the posts 1232 defining the waveguide therein.

Coating/layer 1213 may further extend along the walls defining each of the various antenna slots 1230, one of which is shown in FIG. 12 (others may, of course, be present as well). In addition, in the depicted embodiment, the coating/layer 1213 may be applied to the opposite side of element 1210, which may include a pattern and/or array of scattering elements, as previously discussed. Thus, an array/pattern of scattering elements comprising protruding scattering elements 1216, along with PEC/plate-like scattering elements 1222, may be defined using the same coating/layer 1213, as shown in FIG. 12. Of course, any of the other types, shapes, sizes, and/or patterns of scattering elements may be defined, in some cases wholly defined, or coated/layered with this electrically conductive coating in various alternative embodiments.

In some embodiments, the conductive and/or metallic coating 1213 may comprise, for example, Copper, Nichrome, Aluminum, Silver, or Zinc. As those of ordinary skill in the art will appreciate, different coating materials may be more suitable for specific processes, applications, and/or functions.

In preferred embodiments, conductive and/or metallic coating 1213 may comprise an electroplated coating. However, in other embodiments and related implementations, coating 1213 may be applied in other ways, such as using, for example, metal patterning, metal deposition, and/or photolithography. In other embodiments and/or implementations, conductive and/or metallic coatings may be applied using, for example, physical vapor deposition (PVD) processes, which may include sputter deposition (sputtering) and evaporation.

In some embodiments and implementations, the coating process may include the use of plasma cleaning in order to give a clean surface for the coating to be applied on. For example, a thin adhesive layer of chromium may be sputtered in order to improve the adhesion between plastic and/or absorber material and the conductive and/or metallic coating.

As another example, in some embodiments and implementations, selective plating (partially coating) may be applied by creating a pattern on a mask. This process may involve chemical etching, micromachining, and/or photolithography. A mask for this purpose may be, for example, a glass plate patterned with chromium on one side. In the case of photolithography, by projecting UV light onto the mask, the pattern may be printed to the photoresist, since glass is transparent under UV light while chromium is opaque. Another potentially suitable approach may involve plating the structure and then creating a negative pattern on the mask, which may then be subject to an etching process again.

In some embodiments, plastic materials may be used for coating/layer 1213 that are electrically conductive. Some embodiments may also, or additionally, comprise two or more different types of coatings. For example, a first coating may be applied that is configured to be favorable for signal propagation in the waveguide and/or antenna sections, and a second coating may be applied that is configured for absorption of radio signals.

In some embodiments and related manufacturing methods, the plastic element(s) of the assembly may be injection molded and then coated with one or more metallic layers using any process available to those of ordinary skill in the art. Such coated layers are preferably formed on the plastic piece in a uniform manner.

The foregoing specification has been described with reference to various embodiments and implementations. However, those of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present inventions should, therefore, be determined only by the following claims.

1. A vehicle sensor assembly, comprising:
one or more waveguides;
one or more antenna slots each operably coupled with at least one waveguide of the one or more waveguides; and
an array of scattering elements arranged in a repeating pattern, the pattern comprising a first set of scattering elements and a second set of scattering elements distinct from the first set of scattering elements.

2. The vehicle sensor assembly of claim 1, wherein each of the one or more waveguides, the one or more antenna slots, and the array of scattering elements is formed in a single-layered structure.

3. The vehicle sensor assembly of claim 2, wherein each of the one or more waveguides is formed on a first surface of the single-layered structure, and wherein the array of scattering elements is formed on a second surface of the single-layered structure on an opposite side of the single-layered structure relative to the first surface.

4. The vehicle sensor assembly of claim 1, wherein each member of the first set of scattering elements comprises a plurality of scattering elements, wherein each member of the second set of scattering elements comprises a plurality of scattering elements, and wherein the first set of scattering elements comprises protruding scattering elements.

5. The vehicle sensor assembly of claim 4, wherein the second set of scattering elements comprises recessed scattering elements.

6. The vehicle sensor assembly of claim 5, wherein the recessed scattering elements are formed in at least substantially a complementary, negative shape relative to the protruding scattering elements.

7. The vehicle sensor assembly of claim 1, wherein each member of the first set of scattering elements comprises a plurality of protruding cuboids, and wherein each member of the second set of scattering elements comprises a single protruding cuboid.

8. The vehicle sensor assembly of claim 7, wherein each protruding cuboid of the second set occupies an area at least substantially equal to an area occupied by the plurality of protruding elements of each member of the first set of scattering elements.

9. The vehicle sensor assembly of claim 1, wherein each scattering element in the array of scattering elements is spaced apart from each antenna slot of the one or more antenna slots by a distance of at least one-half of a wavelength of electromagnetic radiation used by the vehicle sensor assembly, and wherein the distance is measured in a direction perpendicular to a direction of an elongated axis of each of the one or more antenna slots.

10. An antenna module, comprising:
one or more waveguides defined on an inner surface;
one or more antenna slots configured to deliver electromagnetic radiation to and/or from a corresponding waveguide therethrough between the inner surface and an outer surface; and
a plurality of destructive interference elements positioned on the outer surface, wherein the destructive interference elements are configured to reduce backscatter radiation by contributing to destructive interference of electromagnetic waves incident upon the destructive interference elements, and wherein the plurality of destructive interference elements comprise at least two distinct types of destructive interference elements arranged adjacent to one another on the outer surface.

11. The antenna module of claim 10, wherein the at least two distinct types of destructive interference elements comprise protruding elements and recessed elements.

12. The antenna module of claim 11, wherein the recessed elements are formed in at least substantially a complementary, negative shape relative to the protruding elements.

13. The antenna module of claim 10, wherein the at least two distinct types of destructive interference elements comprise protruding elements of two distinct sizes, and wherein the at least two distinct types of destructive elements are arranged in an array defined by a repeating pattern in which a plurality of protruding elements of a first, smaller size, are positioned adjacent to a single protruding element of a second, larger size.

14. The antenna module of claim 13, wherein the protruding elements are arranged in the repeating pattern such that the area of each protruding element of the second size is at least substantially the same as the area from which the plurality of protruding elements of the first size extend.

15. The antenna module of claim 10, wherein the waveguide block comprises a thermoplastic material, and wherein each of the plurality of destructive interference elements is defined by an electrically conductive coating applied to the thermoplastic material.

16. A vehicle sensor module, comprising:
a block comprising a first surface and a second surface opposite the first surface;
one or more waveguides defined on the first surface;
one or more antenna slots extending between the first and second surfaces; and
an array of scattering elements defined on the second surface, wherein the array is defined by a repeating pattern comprising rows and columns comprising alternating sets of scattering elements wherein one or more scattering elements of a first type are positioned in a repeating first set adjacent to one or more scattering elements of a second type in a repeating second set along the second surface.

17. The vehicle sensor module of claim 16, wherein the first type comprises artificial magnetic conductors, and wherein the second type comprises artificial magnetic conductors having a distinct shape relative to the first type of artificial magnetic conductors.

18. The vehicle sensor module of claim 16, wherein each member of the first set comprises a plurality of scattering elements.

19. The vehicle sensor module of claim 18, wherein each member of the second set comprises a plurality of scattering elements.

20. The vehicle sensor module of claim 18, wherein each member of the second set comprises a single scattering element, and wherein each of the single scattering elements in each member of the second set occupies an area on the second surface that is at least substantially the same as an area occupied by the plurality of scattering elements in each member of the first set.
